(19) United States
(12) Patent Application Publication
(10) Pub. No.: US 2026/0131511 A1
(43) Pub. Date: May 14, 2026

(54) INJECTION MOLDED PRODUCT EJECTION APPARATUS

(71) Applicants: Hyundai Motor Company, Seoul (KR); Kia Corporation, Seoul (KR)

(72) Inventors: Geun Hwa Park, Hwaseong-Si (KR); Jung Ho Choi, Hwaseong-si (KR); Kyu Young Lee, Hwaseong-Si (KR)

(73) Assignees: Hyundai Motor Company, Seoul (KR); Kia Corporation, Seoul (KR)

(21) Appl. No.: 19/235,982

(22) Filed: Jun. 12, 2025

(30) Foreign Application Priority Data
Nov. 11, 2024 (KR) 10-2024-0159346

(51) Int. Cl. B29C 45/44; B29C 45/40

(52) U.S. Cl. CPC B29C 45/4435; B29C 45/401; B29C 2045/4084

(57) ABSTRACT

An injection molded product ejection apparatus may simultaneously perform an operation in which a first-stage ejection device pushes up the internal portion of an injection molded product by a predetermined height from the surface of a lower mold and an operation in which a second-stage ejection device pushes up the external portions of the injection molded product by the predetermined height from the surface of the lower mold, to enable the injection molded product to be uniformly and stably ejected from the lower mold, and thereafter perform an operation in which the second-stage ejection device secondarily pushes up the external portions of the injection molded product from the surface of the lower mold, to enable a robot gripper to easily pick up the internal portion of the injection molded product and easily remove the injection molded product from the lower mold.

### CROSS-REFERENCE TO RELATED APPLICATION

The present application claims under 35 U.S.C. § 119(a) the benefit of priority from Korean Patent Application No. 10-2024-0159346 filed on Nov. 11, 2024, the entire contents of which are incorporated herein by reference.

### BACKGROUND

### Field of the Present Disclosure

The present disclosure relates to an injection molded product ejection apparatus. It relates to an injection molded product ejection apparatus which may stably eject an injection molded product from a lower mold of a mold set.

### Description of Related Art

Injection molding refers to a process of producing a desired product by injecting a plastic resin molten at a high temperature into the internal cavity of a mold set and then cooling the plastic resin.

A general injection molding process, as shown in FIG. 1, may be conducted in order of a process of injecting a molten resin into a cavity between upper and lower molds of a mold set after closing the lower mold toward the upper mold, a process of cooling the resin injected into the cavity to solidify the resin, and a process of ejecting an injection molded product from the lower mold after opening the lower mold from the upper mold of the mold set.

The conventional process of ejecting the injection molded product was conducted by having a worker directly remove the injection molded product from the mold set, but the present method not only threatens safety of the worker, but also reduces workability and productivity.

To solve the present problem, an ejection robot has been introduced to an injection molding line to replace the role of workers.

Accordingly, the existing process of ejecting the injection molded product is conducted by moving the robot toward the injection molded product placed on the lower mold in a state in which the lower mold is lowered from the upper mold of the mold set, and allowing a gripper disposed at the front end portion of the robot to pick up the injection molded product to remove the injection molded product from the lower mold.

However, if the gripper of the robot picks up and pulls the injection molded product in a state in which the injection molded product is in contact with the lower mold of the mold set, a defect, such as scratches, may occur on the injection molded product when the injection molded product is separated from the surface of the lower mold.

Accordingly, ejection blocks of an ejection device may push up the injection molded product by a predetermined height from the surface of the lower mold before the gripper picks up the injection molded product, allowing the gripper of the robot to stably pick up and remove the injection molded product which is spaced apart from the surface of the lower mold, and thus being capable of preventing occurrence of a defect, such as scratches, on the injection molded product.

However, because the ejection blocks of the conventional ejection device push up only local parts of the injection molded product, the injection molded product (e.g., a bumper cover having a long length) may be ejected from the lower mold in an unbalanced arrangement, and the gripper of the robot may not accurately pick up the product (e.g., a bumper cover having a long length) ejected in the unbalanced arrangement, and may thus cause damage, such as scratches, to the product.

The above information included in this Background section is only for enhancement of understanding of the background of the present disclosure and should not be taken as an acknowledgement or any form of suggestion that this information forms the prior art already known to a person skilled in the art.

### BRIEF SUMMARY

The present disclosure has been made in an effort to solve the above-described problems associated with related art, and it is an object of the present disclosure to provide an injection molded product ejection apparatus which may simultaneously perform an operation in which a first-stage ejection device pushes up the internal portion of an injection molded product by a predetermined height from the surface of a lower mold of a mold set and an operation in which a second-stage ejection device pushes up the external portions of the injection molded product by the predetermined height from the surface of the lower mold may be primarily performed simultaneously, to enable the injection molded product to be uniformly and stably ejected from the lower mold.

It is another object of the present disclosure to provide an injection molded product ejection apparatus that, after an operation in which a first-stage ejection device and a second-stage ejection device primarily push up the internal portion and the external portions of an injection molded product by a predetermined height from the surface of a lower mold, may further perform an operation in which the second-stage ejection device secondarily pushes up the external portions of the injection molded product from the surface of the lower mold, to enable a gripper of a robot to easily pick up the internal portion of the injection molded product and easily remove the injection molded product from the mold set.

In one aspect, the present disclosure provides an injection molded product ejection apparatus including an upper mold and a lower mold to define a cavity for injection molding between the upper mold and the lower mold, a movable holder connected to a lower surface of the lower mold and configured for being raised and lowered, and a push plate disposed below the lower mold with the movable holder interposed therebetween and configured for being raised and lowered, wherein a first-stage ejection device configured to push up an internal portion of an injection molded product in the cavity from the lower mold by raising the push plate after lowering the movable holder and the lower mold with a predetermined distance is disposed in the lower mold and the push plate, and a second-stage ejection device configured to push up external portions of the injection molded product from the lower mold by raising the push plate after lowering the movable holder and the lower mold by the predetermined distance is disposed in the lower mold, the movable holder, and the push plate.

In an exemplary embodiment of the present disclosure, the first-stage ejection device may be configured to push up the internal portion of the injection molded product by a predetermined height from the lower mold.

In another exemplary embodiment of the present disclosure, the first-stage ejection device may include first connection rods inserted into first guide holes formed through internal portions of the lower mold and the movable holder, first ejection blocks disposed on upper end portions of the first connection rods and disposed at the same height as a surface of the lower mold before the push plate is raised, and first bolts fixing lower end portions of the first connection rods to the push plate.

In yet another exemplary embodiment of the present disclosure, first seating recesses configured so that the first ejection blocks are inserted thereinto may be formed on the surface of the lower mold.

In yet another exemplary embodiment of the present disclosure, the second-stage ejection device may be configured to push up the external portions of the injection molded product to a height higher than a predetermined height from the lower mold, after the first-stage ejection device pushes up the internal portion of the injection molded product by the predetermined height from the lower mold.

In still yet another exemplary embodiment of the present disclosure, the second-stage ejection device may include second connection rods inserted into second guide holes formed through external portions of the lower mold and the movable holder and third guide holes formed through the push plate, second ejection blocks disposed on upper end portions of the second connection rods and disposed at the same height as the surface of the lower mold before the push plate is raised, stroke pins disposed at predetermined positions of a lower surface of the movable holder, and driving devices configured to raise the second connection rods and the second ejection blocks by a pressing force of the stroke pins, and disposed on a lower surface of the push plate and lower end portions of the second connection rods inserted into the third guide holes of the push plate.

In a further exemplary embodiment of the present disclosure, second seating recesses configured so that the second ejection blocks are inserted thereinto may be formed on the surface of the lower mold.

In another further exemplary embodiment of the present disclosure, guide holes configured so that the stroke pins are moved therethrough under the push plate when the push plate is raised may be formed through the push plate.

In yet another further exemplary embodiment of the present disclosure, the driving devices may be configured to push up the external portions of the injection molded product to the height higher than the predetermined height from the lower mold, after the first-stage ejection device pushes up the internal portion of the injection molded product by the predetermined height from the lower mold.

In yet another further exemplary embodiment of the present disclosure, each of the driving devices may include a lifting body provided in a structure including a spring support portion formed on an internal circumference of an upper portion thereof, and connected to the lower end portion of a corresponding one of the second connection rods, a spring inserted into the corresponding one of the second connection rods and including an upper end portion compressibly supported by the lower surface of the push plate and a lower end portion supported by the spring support portion of the lifting body, a fixing block disposed at a predetermined position of the push plate, and a cam block disposed on the fixing block to be rotatable upward and downward and configured to rotate upward by the pressing force of a corresponding one of the stroke pins and simultaneously push up the lifting body.

In still yet another further exemplary embodiment of the present disclosure, a pair of coupling end portions may be formed at a front end portion of the cam block, and a pair of coupling holes configured so that the coupling end portions are inserted thereinto to be rotatable upward and downward may be formed in an external circumference of the lifting body.

In a still further exemplary embodiment of the present disclosure, a pressing end portion pressed by the corresponding one of the stroke pins may be formed at a rear end portion of the cam block.

In a yet still further exemplary embodiment of the present disclosure, a spring support protrusion configured so that the upper end portion of the spring is compressibly supported thereby may be formed on an internal diametric portion of a corresponding one of the third guide holes formed in the push plate.

In another exemplary embodiment of the present disclosure, a second bolt may be connected to each of the lower end portions of the second connection rods, and a stopper may be press-fitted between a head of the second bolt and an internal diametric portion of the lifting body.

In yet another exemplary embodiment of the present disclosure, a plug configured to cover the head of the second bolt and the stopper may be inserted into a lower end portion of the lifting body.

In yet another exemplary embodiment of the present disclosure, a guide hole and a female screw portion may be continuously formed at a predetermined position in the lower surface of the movable holder, and a guide pin inserted into the guide hole and a male screw portion connected to the female screw portion may be continuously formed on each of upper end portions of the stroke pins.

In still yet another exemplary embodiment of the present disclosure, a fixture assembly surface including a rectangular cross-section may be formed on a perimeter of each of lower end portions of the stroke pins so that an assembly stroke of a tool is applied thereto.

Other aspects and exemplary embodiments of the present disclosure are discussed infra.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic diagram showing a general injection molding process;

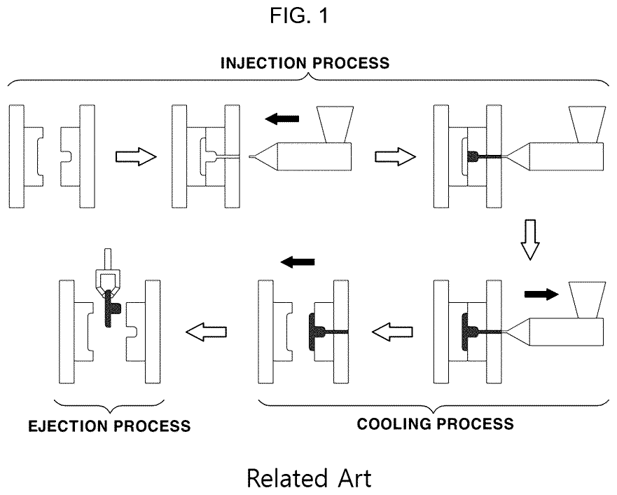

FIG. 2 is a cross-sectional view showing an injection molded product ejection apparatus according to an exemplary embodiment of the present disclosure;

FIG. 3 is an exploded perspective view showing a second-stage ejection device of the injection molded product ejection apparatus according to an exemplary embodiment of the present disclosure;

FIG. 4 is an assembled perspective view showing the second-stage ejection device of the injection molded product ejection apparatus according to an exemplary embodiment of the present disclosure;

FIG. 5 is a bottom perspective view showing a state in which the second-stage ejection device of the injection molded product ejection apparatus according to an exemplary embodiment of the present disclosure is disposed on a push plate;

FIG. 6 is a cross-sectional view showing an operation in which a lower mold, a movable holder, etc. move backward (downward) from an upper mold after injection molding is completed by the injection molded product ejection apparatus according to an exemplary embodiment of the present disclosure;

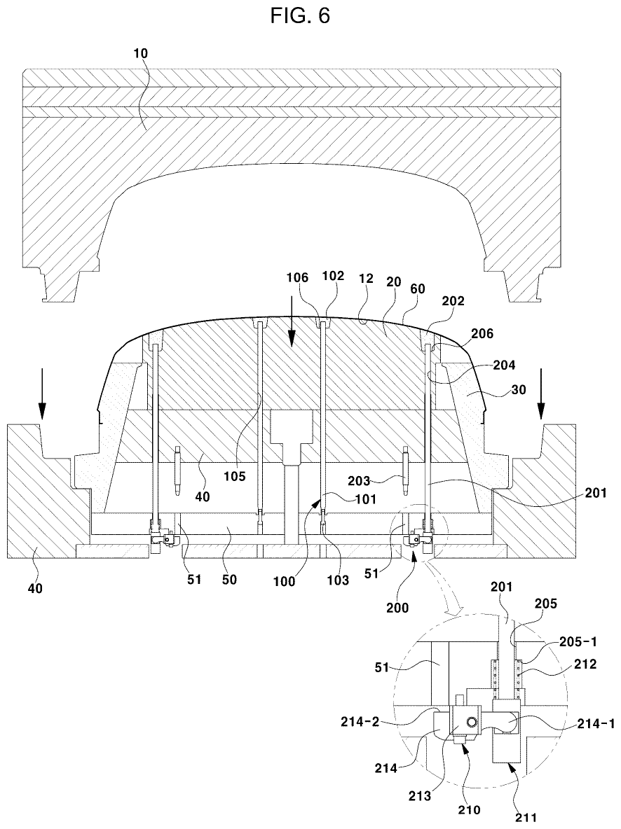

FIG. 7 is a cross-sectional view showing a state in which an injection molded product is primarily raised by a predetermined height from the lower mold by a first-stage ejection device and the second-stage ejection device of the injection molded product ejection apparatus according to an exemplary embodiment of the present disclosure;

FIG. 8 is a cross-sectional view showing a state in which the injection molded product is secondarily raised to a height higher than the predetermined height from the lower mold by the second-stage ejection device of the injection molded product ejection apparatus according to an exemplary embodiment of the present disclosure; and

FIG. 9 is a cross-sectional view showing the assembled structure of a stroke pin among components of the second-stage ejection device of the injection molded product ejection apparatus according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions set forth in the exemplary embodiments of the present disclosure will be merely exemplarily provided to describe the embodiments depending on the concept of the present disclosure, and the embodiments depending on the concept of the present disclosure may be embodied in different forms. Furthermore, the present disclosure should not be construed as being limited to the embodiments set forth herein, and it will be understood that the present disclosure includes all modifications, equivalents, or substitutes included in the spirit and technical scope of the present disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the present disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the following description to refer to the same or like parts. The terminology used herein is for describing various exemplary embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter reference will now be made in detail to various embodiments of the present disclosure, examples of which are illustrated in the accompanying drawings and described below.

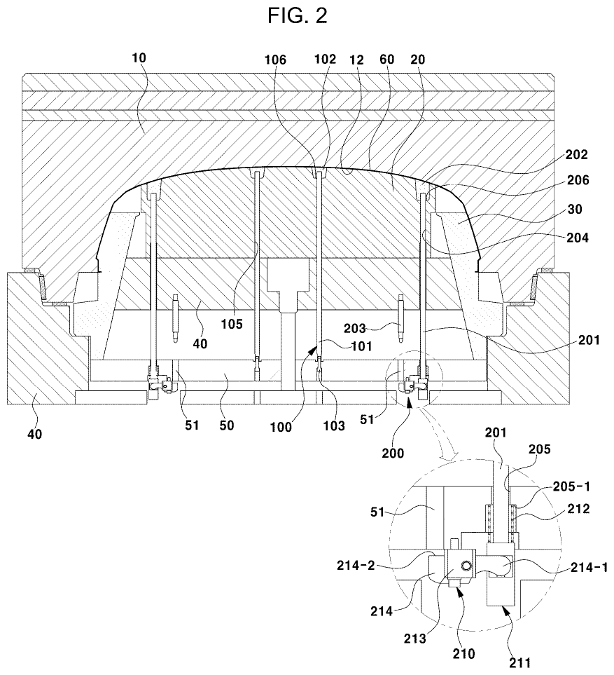

FIG. 2 is a cross-sectional view showing an injection molded product ejection apparatus according to an exemplary embodiment of the present disclosure.

Referring to FIG. 2, a mold set for injection molding may include an upper mold 10, a lower mold 20, inclined cores 30 coupled to both sides of the lower mold 20, a movable holder 40, and a push plate 50.

The upper mold 10 is disposed in a fixed state so as not to move, the lower mold 20 is disposed to be movable upwards and downwards by the movable holder 40, the inclined cores 30 are disposed to be movable left and right, and the push plate 50 is disposed to be configured for being raised and lowered below the lower mold 20 with the movable holder 40 interposed therebetween.

The movable holder 40 may be raised and lowered by an electric lifting drive unit, the lower mold 20 may be raised and lowered also when the movable holder 40 is raised and lowered because the bottom portion of the lower mold 20 is connected to the movable holder 40 to be supported by the movable holder 40, and the push plate 50 may be raised and lowered by a separate electric lifting drive unit.

A cavity 12 is formed between the lower surface of the upper mold 10 and the upper surface of the lower mold 20 to perform injection molding of a product (e.g., a middle portion of a bumper cover), and the cavity 12 is also formed between the lower surface of the upper mold 10 and the upper surfaces of the inclined cores 30 to perform injection molding of the product (e.g., side portions of the bumper cover).

Accordingly, after the lower mold 20 and the inclined cores 30 are clamped to the upper mold 10, when a resin for injection molding is injected into the cavity 12, injection molding of a desired product (e.g., the bumper cover) may be performed within the cavity 12.

Subsequently, a process of cooling the resin injected into the cavity 12 to solidify the resin, and a process of ejecting an injection molded product 60 from the lower mold 20 after opening the mold set by moving the inclined cores 30 inward while lowering the lower mold 20 from the upper mold 10 of the mold set may be performed.

The present disclosure enables a first-stage ejection process of primarily pushing up the internal portion of the injection molded product 60 from the lower mold 20 and a second-stage ejection process of secondarily pushing the external portions of the injection molded product from the lower mold 20 to be performed continuously, focusing on uniformly and stably ejecting the injection molded product 60 (e.g., the bumper cover having a long length) from the lower mold 20.

For the present purpose, a first-stage ejection device 100 that pushes up the internal portion of the injection molded product 60 from the surface of the lower mold 20 defining the cavity 12 when the push plate 50 is raised is disposed between the internal portion of the lower mold 20 and the internal portion of the push plate 50, and a second-stage ejection device 200 that pushes up the external portions of the injection molded product 60 from the surface of the lower mold 20 defining the cavity 12 when the push plate 50 is raised is disposed between the external portions of the lower mold 20 and the external portions of the push plate 50 and on the lower surface of the movable holder 40.

The first-stage ejection device 100 may be configured to push up the internal portion of the injection molded product 60 by a predetermined height from the surface of the lower mold 120 defining the cavity 12.

The first-stage ejection device 100, as shown in FIG. 2, may include first guide holes 105 formed vertically through predetermined positions of the internal portions of the lower mold 20 and the movable holder 40, first connection rods 101 inserted into the first guide holes 105, first ejection blocks 102 disposed on the upper end portions of the first connection rods 101, and first bolts 103 that fix the lower end portions of the first connection rods 101 to the push plate 50.

Here, first seating recesses 106 into which the first ejection blocks 102 are inserted are formed on the surface of the lower mold 20.

Accordingly, the first ejection blocks 102 may be maintained in a state of being inserted into the first seating recesses 106 before the push plate 50 is raised, and the upper surfaces of the first ejection blocks 102 inserted into the first seating recesses 106 may be disposed at the same height as the surface of the lower mold 20.

On the other hand, when the push plate 50 is raised in a state in which the first connection rods 101 and the first ejection blocks 102 are fixed without moving, the first ejection blocks 102 push up the internal portion of the injection molded product 60 by the predetermined height from the surface of the lower mold 20 defining the cavity 12.

The second-stage ejection device 200 is configured to push up the external portions of the injection molded product 60 to a height higher than the predetermined height from the lower mold 20, after the first-stage ejection device 100 pushes up the internal portion of the injection molded product 60 by the predetermined height from the lower mold 20.

That is to say, the second-stage ejection device 200 may be configured to push up the external portions of the injection molded product 60 by the predetermined height from the lower mold 20, when the first-stage ejection device 100 pushes up the internal portion of the injection molded product 60 by the predetermined height from the lower mold 20, and then to push up the external portions of the injection molded product 60 to the height higher than the predetermined height from the lower mold 20.

For the present purpose, the second-stage ejection device 200, as shown in FIG. 2, may include second connection rods 201 continuously inserted into second guide holes 204 formed vertically through predetermined positions of the external portions of the lower mold 20 and the movable holder 40 and third guide holes 205 formed through the push plate 50, second ejection blocks 202 disposed on the upper end portions of the second connection rods 201, stroke pins 203 disposed at predetermined positions of the lower surface of the movable holder 40, and driving devices 210 disposed on the lower surface of the push plate 50 and the lower end portions of the second connection rods 201 inserted into the push plate 50.

Here, second seating recesses 206 into which the second ejection blocks 202 are inserted are formed on the surface of the lower mold 20.

Accordingly, the second ejection blocks 202 may be maintained in a state of being inserted into the second seating recesses 206 before the push plate 50 is raised, and the upper surfaces of the second ejection blocks 202 inserted into the second seating recesses 206 may be disposed at the same height as the surface of the lower mold 20.

Furthermore, guide holes 51, through which the stroke pins 203 disposed on the movable holder 140 are moved under the push plate 50 to provide a pressing force to the driving devices 210 when the push plate 50 is raised, are formed through the push plate 50.

The driving devices 210 are configured to raise the second connection rods 201 and the second ejection blocks 202 by the pressing force of the stroke pins 203, and are disposed on the lower surface of the push plate 50 and the lower end portions of the second connection rods 201 inserted into the push plate 50.

In detail, the driving devices 210 is configured to push up the external portions of the injection molded product 60 to the height higher than the predetermined height from the surface of the lower mold 20 defining the cavity 12, after the first-stage ejection device pushes the internal portion of the injection molded product 60 by the predetermined height from the surface of the lower mold 20 defining the cavity 12.

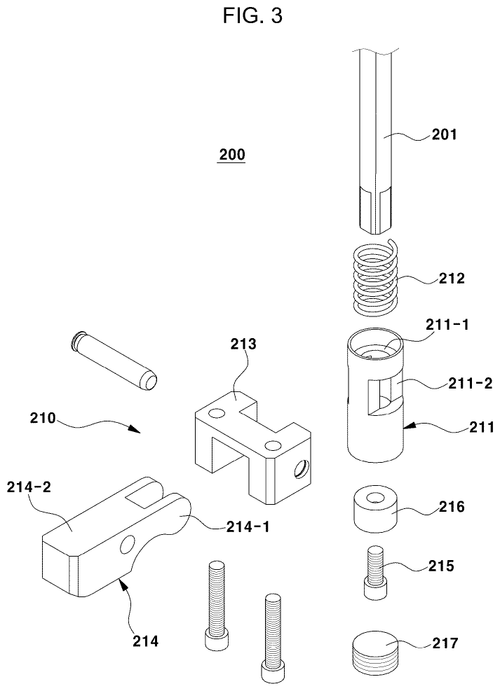

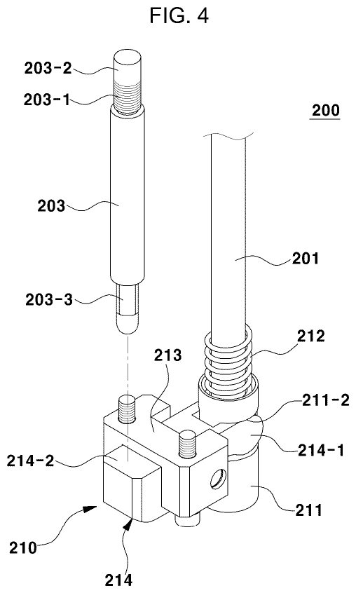

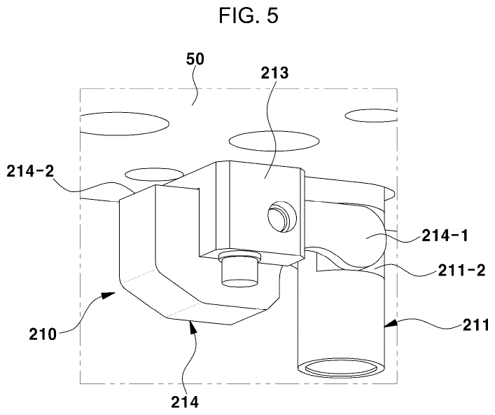

For the present purpose, the driving device 210 may include, as shown in FIGS. 3, 4, and 5, a hollow pipe-shaped lifting body 211 connected to the lower end portion of the second connection rod 201 and including a spring support portion 211-1 formed on the internal circumference of the upper portion of the lifting body 211, a spring 212 including the upper end portion compressibly supported by the lower surface of the push plate 50 and the lower end portion supported by the spring support portion 211-1 of the lifting body 211 in a state in which the spring 212 is inserted into the second connection rod 201, a fixing block 213 fixedly disposed at a predetermined position of the push plate 50 by bolts, and a cam block 214 configured to rotate upward by the pressing force of the stroke pin 203 and simultaneously push up the lifting body 211, and disposed on the fixing block 213 to be rotatable upward and downward.

Furthermore, a second bolt 215 is connected to the lower end portion of the second connection rod 201, and a stopper 216 is press-fitted between the head of the second bolt 215 and the internal diametric portion of the lifting body 211 so that the second connection rod 201 and the lifting body 211 are connected to each other to be raised and lowered together.

Furthermore, a screw-type plug 217 that covers the head of the second bolt 215 and the stopper 216 may be screw-engaged with the lower portion of the lifting body 211 to prevent the second bolt 215 and the stopper 216 from being detached to the outside thereof.

At the present time, a spring support protrusion 205-1 by which the upper end portion of the spring 212 is compressibly supported is formed on the internal diametric portion of the third guide hole 205 formed in the push plate 50, and accordingly, the spring 212 may be compressed when the second connection rod 201 and the lifting body 211 are raised.

Furthermore, the middle portion of the cam block 214 is hinged to the fixing block 213 by a hinge pin, a pair of coupling end portions 214-1 protrudes from the front end portion of the cam block 214, and a pressing end portion 214-2 which is pressed by the stroke pin 204 is formed at the rear end portion of the cam block 214.

Furthermore, a pair of coupling holes 211-2 into which the coupling end portions 214-1 of the cam block 214 are inserted to be rotatable upward and downward is formed in the external circumference of the lifting body 211.

Accordingly, when the movable holder 40 and the lower mold 20 are lowered and then the push plate 50 is raised, the stroke pin 203 passes through the guide hole 51 of the push plate 50 and presses the pressing end portions 214-2 of the cam block 214, and at the instant time, the cam block 214 rotates up and down and the coupling end portions 214-1 of the cam block 214 push the lifting body 211 upward, raising the lifting body 211 and the second connection rod 201.

Therefore, when the lifting body 211 and the second connection rod 201 are raised, the second ejection block 202 disposed on the upper end portion of the second connection rod 20 pushes the external portion of the injection molded product 60 to the height higher than the predetermined height from the surface of the lower mold 20 defining the cavity 12.

Meanwhile, when the stroke pin 203 is assembled to the predetermined position on the lower surface of the movable holder 40, a worker directly assembles the stroke pin 203 to the movable holder 40 using a tool, such as a wrench, in a narrow work space, a male screw portion formed on the upper end portion of the stroke pin 203 may not be completely inserted and connected to a female screw portion formed at the predetermined position on the lower surface of the movable holder 40.

For example, when the male screw portion formed on the upper end portion of the stroke pin 203 is engaged with the female screw portion formed at the predetermined position on the lower surface of the movable holder 40, if the male screw portion is not completely engaged with the female screw portion but the stroke pin 203 not rotates, the worker may incorrectly assume that the stroke pin 203 is completely engaged with the movable holder 40.

Accordingly, if the stroke pin 203 is completely engaged with the movable holder 40, the protruding length of the stroke pin 203 protruding from the lower surface of the movable holder 40 may be longer than a set length, and as a result, the stroke when the stroke pin 203 presses the pressing end portion 214-2 of the cam block 214 may become longer, being configured for damaging the cam block 214 and surrounding portions.

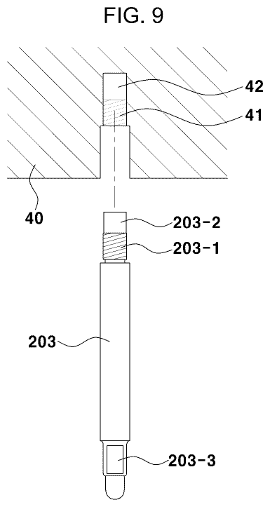

To prevent this, as shown in FIG. 9, a guide hole 42 and a female screw portion 41 are continuously formed at a predetermined position in the lower surface of the movable holder 40, and a guide pin 203-2 inserted into the guide hole 42 and a male screw portion 203-1 connected to the female screw portion 41 are continuously formed on the upper end portion of the stroke pin 203.

For example, the guide pin 203-2 of the stroke pin 203 is cut to have a smaller diameter than the diameter of the female screw portion 41 and inserted straight into the guide hole 42 of the movable holder 40, being configured for maintaining straightness when assembling the stroke pin 203 with the movable holder 40.

Accordingly, when the worker screws the male screw portion 203-1 of the stroke pin 203 into the female screw portion 41 of the movable holder 30, the male screw portion 203-1 of the stroke pin 203 is screwed into the female screw portion 41 of the movable holder 30 until the guide pin 203-2 of the stroke pin 203 reaches the end portion of the guide hole 42 of the movable holder 40, i.e., until the stroke pin 203 not rotates, allowing the stroke pin 203 to be disposed straight in the vertical direction and adjusting the protruding length of the stroke pin 203 protruding from the lower surface of the movable holder 40 to the set length.

A fixture assembly surface 203-3 including a rectangular cross-section may be formed on the perimeter of the lower end portion of the stroke pin 203 so that an assembly fixture connected to a wrench may be easily connected to the fixture assembly surface 203-3, and accordingly, the worker may easily apply an assembly stroke to the stroke pin 203 using a tool, such as the wrench.

Here, the operation flow of the injection molded product ejection apparatus of the present disclosure including the above-described configuration is as follows.

First, as shown in FIG. 2, after the lower mold and the inclined cores 30 are clamped to the upper mold 10, when a resin for injection molding is injected into the cavity 12, injection molding of a desired product (e.g., a bumper cover) is performed within the cavity 12.

Subsequently, the process of cooling the resin injected into the cavity 12 to solidify the resin and the process of opening the mold set by moving the inclined cores 30 inward while lowering the lower mold 20 and the movable holder 40 from the upper mold 10 of the mold set are performed.

For the present purpose, the movable holder 40 may be lowered with a predetermined distance by the electric lifting drive unit, the lower mold 20 may also be lowered by the same distance when the movable holder 40 is lowered because the bottom portion of the lower mold 20 is connected to the movable holder 40 to be supported by the movable holder 40, and the push plate 50 may be lowered by the same distance by the separate electric lifting drive unit.

Nex, the process of ejecting the injection molded product 60 from the lower mold 20 may be performed.

The process of ejecting the injection molded product 60 may be performed by a first-stage ejection operation in which the first-stage ejection device 100 pushes up the internal portion of the injection molded product 60 by a predetermined height from the lower mold 20 and the second-stage ejection device 200 pushes up the external portions of the injection molded product 60 by the predetermined height from the lower mold 20, and a second-stage ejection operation in which the second-ejection device 200 pushes up the external portions of the injection molded product 60 to a height higher than the predetermined height from the lower mold 20.

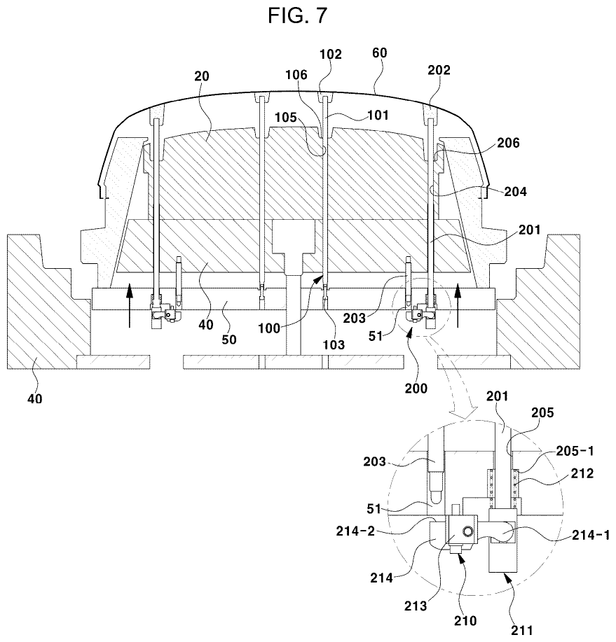

For the present purpose, the first-stage ejection operation of the process of ejecting the injection molded product 60 may be conducted, as shown in FIG. 7, by simultaneously performing an operation in which, when the first push plate 50 is raised by a predetermined length to push the first connection rods 101 in a state in which the first connection rods 101 and the first ejection blocks 102 are fixed without moving, the first ejection blocks 102 connected to the upper end portions of the first connection rods 101 push up the internal portion of the injection molded product 60 by the predetermined height from the surface of the lower mold 20 defining the cavity 12, and an operation in which, when the first push plate 50 is raised by the predetermined length to push the second connection rods 201 in a state in which the second connection rods 201 and the second ejection blocks 202 are fixed without moving, the second ejection blocks 202 connected to the upper end portions of the second connection rods 201 push up the external portions of the injection molded product 60 by the predetermined height from the surface of the lower mold 20 defining the cavity 12.

At the present time, even if the injection molded product 60 is raised by the predetermined height from the surface of the lower mold 20 defining the cavity 12, the state in which the internal portion of the injection molded product 60 is supported by the first ejection blocks 102 and the state in which the external portions of the injection molded product 60 are supported by the second ejection blocks 202 are maintained.

If only the first ejection blocks 102 push up the internal portion of the injection molded product 60 by the predetermined height from the surface of the lower mold 20 defining the cavity 12, the external portions of the injection molded product 60 may not be properly ejected from the lower mold 20.

Furthermore, when only the first ejection blocks 102 push up the internal portion of the injection molded product 60 by the predetermined height from the surface of the lower mold 20 defining the cavity 12, even if the external portions of the injection molded product 60 are ejected from the lower mold 20, the external portions of the injection molded product 60 may not be supported and thus sag downward, and ultimately, the injection molded product 60 (e.g., the bumper cover having a long length) may be ejected in an unbalanced arrangement from the lower mold 20.

On the other hand, according to an exemplary embodiment of the present disclosure, the first ejection blocks 102 push up the internal portion of the injection molded product 60 by the predetermined height from the surface of the lower mold 20 defining the cavity 12, and at the same time, the second ejection blocks 202 push up the external portions of the injection molded product 60 by the predetermined height from the surface of the lower mold 20 defining the cavity 12, being configured for maintaining the state in which the internal portion of the injection molded product 60 is supported by the first ejection blocks 102 and the external portions of the injection molded product 60 are supported by the second ejection blocks 202 and thus ultimately ejecting the injection molded product 60 (e.g., the bumper cover including the long length) in a stable and balanced arrangement from the lower mold 20.

Furthermore, when a gripper of a robot picks up the injection molded product 60 and removes it from the mold set in the state in which the injection molded product 60 is raised by the predetermined height from the lower mold 20 and supported by the first ejection blocks 102 and the second ejection blocks 202, interference between the gripper of the robot and the first ejection blocks 102 may occur, and thus the gripper may not stably pick up the injection molded product 60 and cause damage, such as scratches, to the injection molded product 60.

To solve the present problem, after the first-stage ejection operation in which the injection molded product 60 is raised by the predetermined height from the lower mold 20 is performed, the second-stage ejection operation in which the external portions of the injection molded product 60 is raised to the height higher than the predetermined height from the lower mold 20 by operating the second-stage ejection device 200 may be continuously performed.

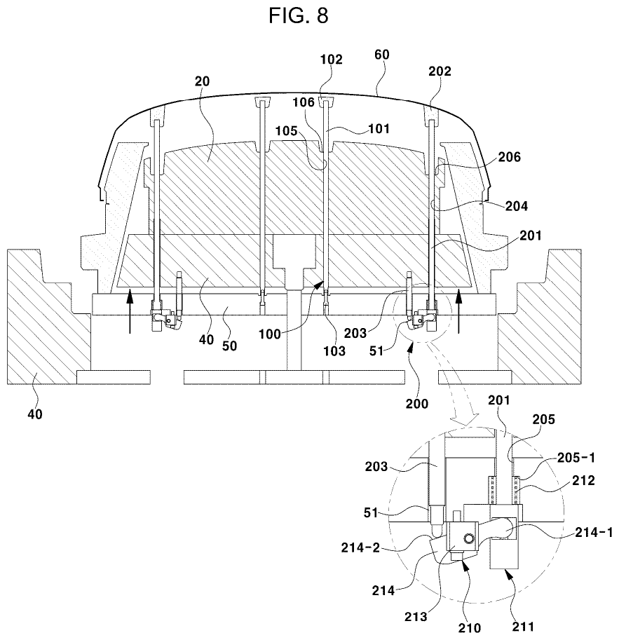

For the present purpose, the second-stage ejection operation during the process of ejecting the injection molded product 60 may be performed, as shown in FIG. 8, in order of an operation in which the stroke pins 203 pass through the guide holes 51 of the push plate 50 and press the pressing end portions 214-2 of the cam blocks 214 downward, an operation in which the cam blocks 214 rotate upward, and at the same time, the coupling end portions 214-1 of the cam blocks 214 push up the lifting bodies 211, and an operation in which the lifting bodies 211 and the second connection rods 201 are raised.

In succession, due to raising of the lifting bodies 211 and the second connection rods 201, the second ejection blocks 202 disposed on the upper end portions of the second connection rods 201 push up the external portions of the injection molded product 60 to the height higher than the predetermined height from the surface of the lower mold 20 defining the cavity 12.

Therefore, as shown in FIG. 8, in the state in which the external portions of the injection molded product 60 are supported by the second ejection blocks 202, the internal portion of the injection molded product 60 is raised to be spaced apart from the upper surfaces of the first ejection blocks 102.

That is to say, only the external portions of both sides of the injection molded product 60 are supported by the second ejection blocks 202, and the internal portion of the injection molded product 60 picked up by the gripper of the robot is in a state of being spaced apart from the upper surfaces of the first ejection blocks 102.

In the present way, because the internal portion of the injection molded product 60 picked up by the gripper of the robot is in the state of being spaced apart from the upper surfaces of the first ejection blocks 102, interference between the gripper of the robot and the first ejection blocks 102 when the gripper picks up the internal portion of the injection molded product 60 may be prevented, and as a result, the gripper of the robot may easily pick up the internal portion of the injection molded product 60 spaced apart from the upper surfaces of the first ejection blocks 102 and easily remove the injection molded product 60 from the mold set.

As is apparent from the above description, the present disclosure provides the following effects.

First, an operation in which first ejection blocks of a first-stage ejection device push up the internal portion of an injection molded product by a predetermined height from the surface of a lower mold of a mold set and an operation in which second ejection blocks of a second-stage ejection device push up the external portions of the injection molded product by the predetermined height from the surface of the lower mold may be primarily performed simultaneously, enabling the injection molded product (e.g., a bumper cover having a long length) to be uniformly and stably ejected from the lower mold.

Second, after primarily pushing up the internal portion and the external portions of the injection molded product by the predetermined height from the surface of the lower mold, an operation in which the second ejection blocks of the second-stage ejection device secondarily push up the external portions of the injection molded product from the surface of the lower mold may be further performed, enabling a gripper of a robot to easily pick up the internal portion of the injection molded product spaced apart from the upper surfaces of the first ejection blocks and easily remove the injection molded product from the mold set.

The present disclosure has been described in detail with reference to exemplary embodiments thereof. However, it will be appreciated by those skilled in the art that changes may be made in these embodiments without departing from the principles and spirit of the present disclosure, the scope of which is defined in the appended claims and their equivalents.

What is claimed is:

1. An injection molded product ejection apparatus comprising:
an upper mold and a lower mold to define a cavity for injection molding between the upper mold and the lower mold;
a movable holder connected to a lower surface of the lower mold and configured for being raised and lowered;
a push plate disposed below the lower mold with the movable holder interposed therebetween and configured for being raised and lowered;
a first-stage ejection device disposed in the lower mold and the push plate and configured to push up an internal portion of an injection molded product in the cavity from the lower mold by raising the push plate after lowering the movable holder and the lower mold with a predetermined distance; and
a second-stage ejection device disposed in the lower mold, the movable holder, and the push plate and configured to push up external portions of the injection molded product from the lower mold by raising the push plate after lowering the movable holder and the lower mold by the predetermined distance.

2. The injection molded product ejection apparatus of claim 1, wherein the first-stage ejection device is further configured to push up the internal portion of the injection molded product by a predetermined height from the lower mold.

3. The injection molded product ejection apparatus of claim 2, wherein the first-stage ejection device comprises:
first connection rods inserted into first guide holes formed through internal portions of the lower mold and the movable holder;
first ejection blocks disposed on upper end portions of the first connection rods and disposed at the same height as a surface of the lower mold before the push plate is raised; and
first bolts fixing lower end portions of the first connection rods to the push plate.

4. The injection molded product ejection apparatus of claim 3, further comprising first seating recesses formed on the surface of the lower mold and configured so that the first ejection blocks are inserted thereinto.

5. The injection molded product ejection apparatus of claim 1, wherein the second-stage ejection device is further configured to push up the external portions of the injection molded product to a height higher than a predetermined height from the lower mold, after the first-stage ejection device pushes up the internal portion of the injection molded product by the predetermined height from the lower mold.

6. The injection molded product ejection apparatus of claim 5, wherein the second-stage ejection device comprises:
second connection rods inserted into second guide holes formed through external portions of the lower mold and the movable holder and third guide holes formed through the push plate;
second ejection blocks disposed on upper end portions of the second connection rods and disposed at the same height as the surface of the lower mold before the push plate is raised;
stroke pins disposed at predetermined positions of a lower surface of the movable holder; and
driving devices configured to raise the second connection rods and the second ejection blocks by a pressing force of the stroke pins, and disposed on a lower surface of the push plate and lower end portions of the second connection rods inserted into the third guide holes of the push plate.

7. The injection molded product ejection apparatus of claim 6, further comprising second seating recesses formed on the surface of the lower mold and configured so that the second ejection blocks are inserted thereinto.

8. The injection molded product ejection apparatus of claim 6, further comprising guide holes formed through the push plate and configured so that the stroke pins are moved therethrough under the push plate when the push plate is raised.

9. The injection molded product ejection apparatus of claim 6, wherein the driving devices are configured to push up the external portions of the injection molded product to a height higher than the predetermined height from the lower mold, after the first-stage ejection device pushes up the internal portion of the injection molded product by the predetermined height from the lower mold.

10. The injection molded product ejection apparatus of claim 6, wherein each of the driving devices comprises:
a lifting body provided in a structure including a spring support portion formed on an internal circumference of an upper portion thereof, and connected to the lower end portion of a corresponding one of the second connection rods;
a spring inserted into the corresponding one of the second connection rods and including an upper end portion compressibly supported by the lower surface of the push plate and a lower end portion supported by the spring support portion of the lifting body;
a fixing block disposed at a predetermined position of the push plate; and
a cam block disposed on the fixing block to be rotatable upward and downward and configured to rotate upward by the pressing force of a corresponding one of the stroke pins and simultaneously push up the lifting body.

11. The injection molded product ejection apparatus of claim 10, wherein a pair of coupling end portions are formed at a front end portion of the cam block, and a pair of coupling holes configured so that the coupling end portions are inserted thereinto to be rotatable upward and downward is formed in an external circumference of the lifting body.

12. The injection molded product ejection apparatus of claim 10, wherein a pressing end portion pressed by the corresponding one of the stroke pins is formed at a rear end portion of the cam block.

13. The injection molded product ejection apparatus of claim 10, further comprising a spring support protrusion formed on an internal diametric portion of a corresponding one of the third guide holes formed in the push plate and configured so that the upper end portion of the spring is compressibly supported thereby.

14. The injection molded product ejection apparatus of claim 6, further comprising a second bolt and a stopper, wherein the second bolt is connected to each of the lower end portions of the second connection rods, and the stopper is press-fitted between a head of the second bolt and an internal diametric portion of the lifting body.

15. The injection molded product ejection apparatus of claim 14, further including a plug, wherein the plug configured to cover the head of the second bolt and the stopper is inserted into a lower end portion of the lifting body.

16. The injection molded product ejection apparatus of claim 6, wherein a guide hole and a female screw portion are continuously formed at a predetermined position in the lower surface of the movable holder, and a guide pin inserted into the guide hole and a male screw portion connected to the female screw portion are continuously formed on each of upper end portions of the stroke pins.

17. The injection molded product ejection apparatus of claim 16, wherein a fixture assembly surface including a rectangular cross-section is formed on a perimeter of each of lower end portions of the stroke pins so that an assembly stroke of a tool is applied thereto.

18. An injection molding method comprising:
pushing up, by a first-stage ejection device, an internal portion of an injection molded product in a cavity from a lower mold by raising a push plate after lowering a movable holder and the lower mold with a predetermined distance; and
pushing up, by a second-stage ejection device, external portions of the injection molded product from the lower mold by raising the push plate after lowering the movable holder and the lower mold by the predetermined distance.

19. The injection molding method of claim 18, further comprising:
pushing up, by the first-stage ejection device, the internal portion of the injection molded product by a predetermined height from the lower mold.

20. The injection molding method of claim 18, further comprising:
pushing up, by the second-stage ejection device, the external portions of the injection molded product to a height higher than a predetermined height from the lower mold, after the first-stage ejection device pushes up the internal portion of the injection molded product by the predetermined height from the lower mold.
